(19) United States
(12) Patent Application Publication
(10) Pub. No.: US 2009/0274793 A1
(43) Pub. Date: Nov. 5, 2009

(54) Wine Making Method

(76) Inventor: Daryl Stephan Schroeder, Winnipeg (CA)

Correspondence Address: ADE & COMPANY INC., 2157 Henderson Highway, WINNIPEG, MB, R2G1P9, CA

(21) Appl. No.: 12/434,905

(22) Filed: May 4, 2009

Related U.S. Application Data
(60) Provisional application No. 61/049,886, filed on May 2, 2008.

(51) Int. Cl. C12G 1/00

(52) U.S. Cl. 426/8; 426/15; 99/277

(57) ABSTRACT

In a method of making wine comprising fermenting a mixture in a main batch container to produce wine and transferring the wine from the main batch container to a plurality of bottles, at least a portion of the wine is exposed to a vacuum pressure during the wine making process prior to bottling. The wine is thus degassed without the stress of agitation or filtering being required. The wine is also transferable either for racking to remove sediment or when bottling in a manner which reduces sediment uptake into the siphon tubes and which reduces stress from agitations applied to the wine using vacuum pressure.

This application claims the benefit under 35 U.S.C. 119(e) of U.S. provisional application Ser. No. 61/049,886, filed May 2, 2008.

### FIELD OF THE INVENTION

The present invention relates to a method of making wine in which a vacuum pressure is applied to the wine for degassing the wine prior to bottling and for assisting in siphoning the wine from a main batch container to an auxiliary batch container or to bottles.

### BACKGROUND

Most wine makers are proud of their hobby and strive to make pleasurable tasting wine. Currently on the market for degassing wine are only units that “agitate” the wine to degas it. At first glance this is a standard procedure, and seems to work well. The units to agitate/degas are manually operated such as a long ladle to units that attach to a hand drill. While agitating they seem to work well to degas the wine, but after you stop all “degassing” stops as well. The only time the wine is actually degassing is when it is being agitated. With the current method of degassing you are violently stirring/mixing the wine which in turn you are “stressing” the wine causing longer aging periods to get a palatable tasting wine. With the current units available you are introducing ambient air directly into the wine and mixing it. Ambient air is full of contaminants and the possibility of exposing your wine to “wild yeasts” exists and could potentially ruin the wine.

U.S. Pat. No. 4,512,251 belonging to Green discloses a device for assisting in breathing wine after a bottle of wine is opened for consumption. No means are disclosed or suggested however as to how the device may be used in assisting the wine making process before bottling of the wine.

International patent application number WO 2004/099360 belonging to Vinterus Technologies LLC discloses a device for filtering wine when bottling in which a vacuum is used to assist drawing wine through a filter in some embodiments. No means are suggested however as to how to assist degassing a wine prior to bottling.

### SUMMARY OF THE INVENTION

According to one aspect of the invention there is provided, in a method of making wine comprising fermenting a mixture in a main batch container to produce wine and transferring the wine from the main batch container to a plurality of bottles, an improvement comprising exposing at least a portion of the wine to a vacuum pressure.

Preferably a vacuum pressure is applied to the main batch container to degas the wine in the main batch container prior to transferring the wine to the plurality of bottles.

Preferably the vacuum pressure is applied to the main batch container at a first prescribed vacuum pressure for an initial prescribed duration followed by a second vacuum pressure greater than the first vacuum pressure for a subsequent duration which is greater than the initial prescribed duration. The first prescribed vacuum pressure may be approximately 10 psi of vacuum pressure relative to atmosphere.

The vacuum pressure may be applied to an auxiliary container connected to the batch container by a siphon tube.

An adapter may be arranged to be sealably engaged within a neck opening of the auxiliary container, the adapter including a first port communicating through the adapter in communication with a source of the vacuum pressure and a second port communicating through the adapter in communication with the siphon tube.

The siphon tube may be arranged to communicate with each of the containers adjacent a bottom end thereof.

The source of the vacuum pressure is preferably arranged to communicate with the auxiliary container adjacent a top end thereof.

The vacuum pressure may be applied with a vacuum source comprising a vacuum pump and a controllable valve arranged to controllably set the vacuum pressure applied to the wine to a set point vacuum pressure.

A pressure gauge may be provided in communication with the vacuum source and operating the control valve to introduce air into a vacuum line communicating between the vacuum source and the container until the set point vacuum pressure is indicated on the gauge.

The auxiliary container preferably comprises an auxiliary batch container arranged to receive the wine therein when racking the wine from the main batch container to the auxiliary batch container.

The wine may be prevented from being prematurely degassed by preventing the vacuum pressure applied to the auxiliary batch container from exceeding a prescribed threshold.

The auxiliary container may comprise one bottle of the plurality of bottles to which the wine from the main batch container is transferred.

A vacuum line may be provided in communication between a source of the vacuum pressure and the auxiliary container and a control port in communication between atmosphere and the vacuum line. The control port is preferably adjacent the auxiliary container.

According to a second aspect of the present invention there is provided a wine degasifying system for use with a batch container having a neck opening and being arranged to receive wine corresponding to a plurality of bottles therein, the system comprising:

a plug arranged to be received in the neck opening in sealing engagement therewith, the plug including a vacuum port communicating therethrough between inner and outer ends of the plug;

a vacuum pump arranged to produce a vacuum pressure at an inlet of the pump;

a vacuum line in communication between the vacuum port in the plug and the inlet of the pump.

There may be provided a control valve in communication with the vacuum line and arranged to controllably adjust a magnitude of a vacuum pressure applied by the vacuum pump to the vacuum line.

According to a further aspect of the present invention there is provided a wine transferring system for transferring wine from a batch container arranged to receive wine corresponding to a plurality of bottles therein, the system comprising:

an auxiliary container having a neck opening and being arranged to receive the wine therein;

a plug arranged to be received in the neck opening in sealing engagement therewith, the plug including a vacuum port and an auxiliary port communicating therethrough between inner and outer ends of the plug;

a vacuum pump arranged to produce a vacuum pressure at an inlet of the pump;

a vacuum line in communication between the vacuum port in the plug and the inlet of the pump;

a siphon line arranged for communication between the auxiliary port at the outer end of the plug and the batch container.

There may be provided a stem arranged to communicate between the auxiliary port at the inner end of the plug and a bottom end of the auxiliary container.

There may also be provided a control valve in communication with the vacuum line and arranged to controllably maintain a magnitude of a vacuum pressure applied by the vacuum pump to the vacuum line below a prescribed vacuum threshold so as to prevent premature degasification of the wine.

By applying a vacuum to a portion of the wine in a main batch container during the wine making process prior to bottling, the wine can be degassed without the stress of agitation or filtering being required. Further a method is disclosed in which wine can be transferred either for racking to remove sediment or when bottling in a manner which reduces sediment uptake into the siphon tubes and which reduces stress from agitations applied to the wine.

By using the invention one can apply vacuum to the industry standard carboy and pull the gas out directly and will not be exposing the wine to ambient air. This gentle method of degassing will not stress the wine and makes it palatable sooner, so one can enjoy the fruits of their labour more quickly. In test carboys, it is also of note that the wine clears more quickly by using the present invention.

The invention has an additional feature and can be used effortlessly to transfer wines from one carboy to another for the purpose of racking and can be done on the same elevation. Common racking procedures require that you have the wine source carboy at a higher elevation than the target carboy you want to rack into. A hose is used to siphon out the wine into the new carboy by using gravity again exposing your must to ambient air. With the invention, racking/transfer can be done at the same elevation, so you will never have to lift a carboy full of wine back onto the table again. Glass carboys full of wine can weigh up to 60 lbs. This will be helpful for a person who has physical limitations, or for seniors who enjoy wine making but have lost strength, as they have gotten older. After starting your wine in the primary fermentor you can rack your wine as often as you like and never have to physically lift a carboy again.

The final feature of the invention is the simplicity of the bottling process. You attach the invention to a special bung that fits onto a 750 ml or 1.5 L standard wine bottle. Turn on the machine and vacuum will draw the wine into the bottle at a very quick rate. This too can be all done at the same elevation as your wine source.

Various embodiments of the invention will now be described in conjunction with the accompanying drawings in which:

### BRIEF DESCRIPTION OF THE DRAWINGS

FIG. 1 is a schematic illustration of a vacuum device operated according to a first mode of the present invention.

FIG. 2A is a plan view of an adapter for use in the first mode.

FIG. 2B is a cross sectional view along the line 2B-2B of FIG. 2B.

FIG. 3 is a schematic illustration of the internal components of the vacuum device.

FIG. 4 is a top plan view of the housing of the vacuum device.

FIG. 5 is a schematic illustration of the electrical components of the vacuum device.

FIG. 6 is a schematic illustration of the vacuum device operated according to a second mode of the present invention.

FIG. 7 is a sectional elevational view of a second embodiment of the adapter for use in the second mode of FIG. 6.

FIG. 8 is a schematic illustration of the vacuum device operated according to a third mode of operation.

FIG. 9 is a sectional elevational view of a third embodiment of the adapter for use in the third mode of operation.

In the drawings like characters of reference indicate corresponding parts in the different figures.

### DETAILED DESCRIPTION

A primary purpose for the device is to degas homemade/kit wine prior to bottling. A secondary purpose of the device is for transferring wine from one carboy to another for the purpose of racking. Racking is an essential part of the wine making process, as you want to dispose of sediment and spent yeast. A third purpose of the device is to transfer wine from the bulk carboy into 750 ml or 1.5 L wine bottles for bottling.

Referring to the accompanying figures there is illustrated a vacuum device generally indicated by reference numeral 10. The vacuum device 10 is particularly useful in a method of making wine to assist in the steps of degassing in a first mode, racking or transferring wine between different batch containers in a second mode and for bottling wine in a third mode.

The vacuum device comprises a small portable housing 12 which is generally rectangular in shape. Within the housing there is provided a vacuum pump 14 having an inlet which draws a vacuum pressure in a suction line 16 communicating between the inlet of the vacuum pump and an inlet port 18 supported externally on the housing.

A control valve 20 is also supported externally on the housing for communication with the suction line 16 between the pump 14 and the inlet port 18. The control valve 20 defines an auxiliary opening of adjustable cross section for controllably varying an amount of air allowed to be introduced into the suction line for selectively breaking vacuum and returning the inlet port 18 on the housing in varying degrees back towards atmospheric pressure as controlled by the user with the control valve 20.

A vacuum gauge 21 connected to the suction line 16 provides an indication of the vacuum pressure in the line relative to atmospheric pressure. By adjusting the control valve and observing the indication of pressure on the gauge, vacuum pressure in the suction line can be adjusted or controlled to a set point pressure.

The vacuum device further includes an electrical socket 22 which allows the device to be connected to grid power by a suitable extension cord 24. The socket 22 is connected through an external power switch 26 mounted on the housing to the pump 14 which is electrically driven.

A transformer 28 is coupled in parallel with the electric pump and is in turn connected to a cooling fan 30 supported in the housing. Suitable vents are provided in the housing to permit an airflow across the pump when the cooling fan 30 is operated. The cooling fan and the electric vacuum pump 14 are coupled in parallel so as to be turned on and off together with operation of the power switch 26.

The vacuum device 10 is part of a vacuum system including a vacuum line 32 which is coupled to the inlet port 18 at one end and to a suitable adapter 34 at the opposing end. Various configurations of adapters 34 are provided for accommodating the various modes of operation of the vacuum device of the present invention. In each instance, the adapters 34 are arranged for communication in some manner with the wine from a main batch container 36 of the type used in the process of making wine, and more particularly of making wine from homemade wine kits.

Typically when making wine, fermenting is accomplished in two stages in a primary fermentor and a secondary fermentor respectively. The secondary fermentor is commonly referred to as carboy and performs the function of the main batch container 36 described herein.

In the process of making wine, one step known racking involves the wine being typically transferred from the main batch container to an auxiliary batch container at various times during the fermenting process so that sediment at the bottom of the main batch container is left behind to be separated from the wine being made. In another step in the wine making process, wine in a batch container prior to bottling is degassed, typically by agitating the wine in prior art configurations. After degassing, the wine is typically transferred from the batch container into a plurality of individual bottles which are then corked or capped in the bottling process.

In all modes of the invention, the adapter 34 typically comprises a plug which is arranged to be resiliently received in sealing engagement within the neck opening 38 of the container upon which it is mounted. A vacuum port 40 extends fully through the adapter in an axial direction of the neck opening in which the adapter is received. The vacuum port 40 communicates between an inner end opening arranged to communicate adjacent the top end of the container within which the adapter is received and a nipple 42 at the external end which is arranged for sealing engagement with the vacuum line 32. Accordingly when the vacuum device 10 is operated, and the control valve 20 is at least partially closed, a vacuum pressure relative to atmospheric pressure is introduced in the container within which the wine is located or received according to the various modes of the present invention.

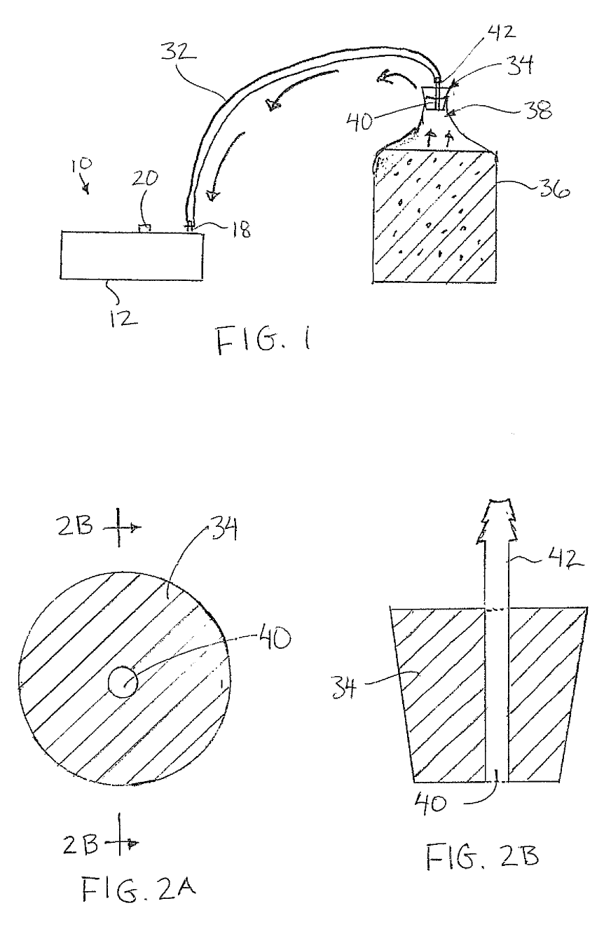

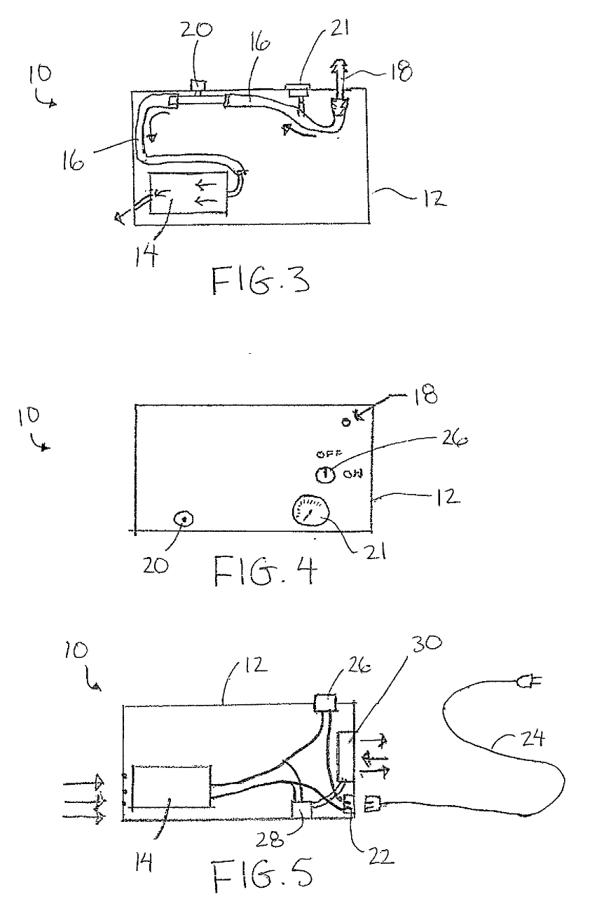

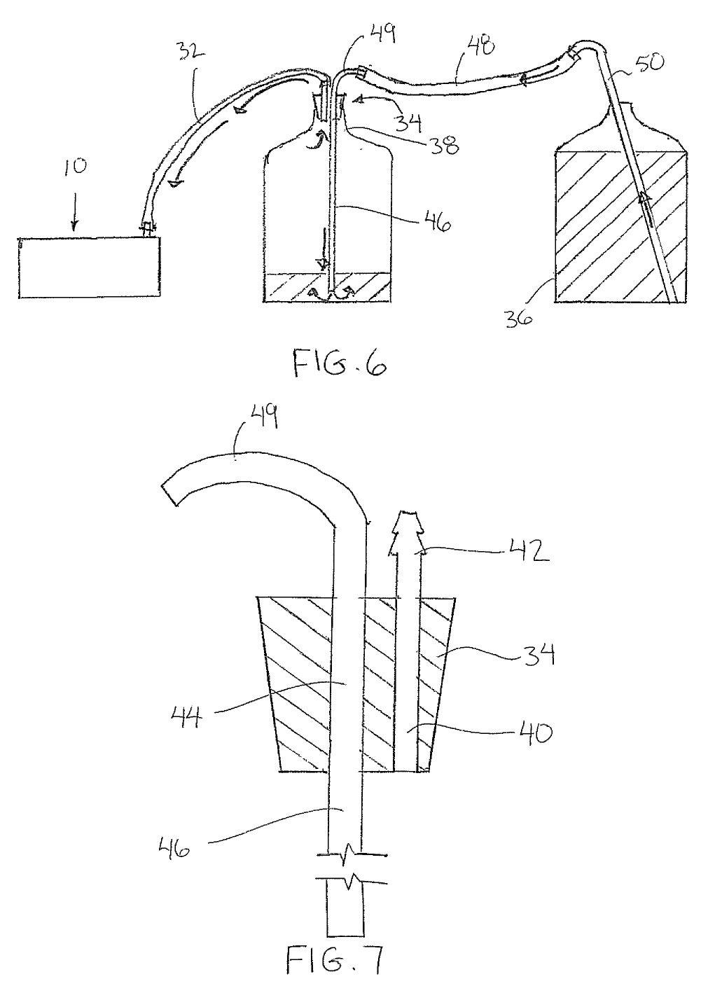

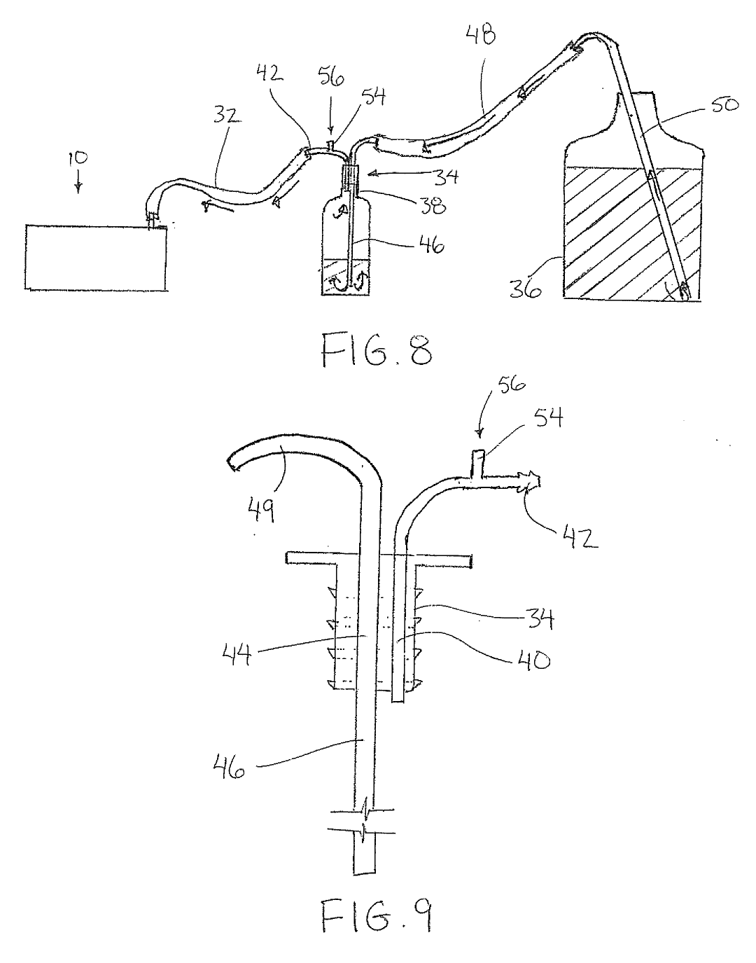

According to the first mode as shown in FIGS. 1 and 2, the adapter 34 is arranged for sealing engagement within the neck opening of a conventional carboy of the type used in homemade wine making kits. The only port communicating through the adapter comprises the vacuum port 40 so that operation of the vacuum device causes the interior of the main batch container having wine therein to be reduced to vacuum pressure to encourage gasses in solution within the wine to come out of solution and be removed from the wine in the main batch container. In the first mode, the vacuum device is typically operated in two stages. Initially the control valve 20 is used to set the vacuum pressure in the suction line to be stabilised relative to the main batch container at a vacuum pressure corresponding to approximately 10 psi below atmospheric pressure.

Vacuum pressure is maintained at the first set point pressure for an initial prescribed duration for example twenty minutes to release an initial large volume of gas from the wine. After the initial volume of gas is removed, for extended removal of further gas, the vacuum applied by the vacuum device is controlled by the control valve to a second set point vacuum pressure which is much greater than the first set point pressure. The second set point pressure is also maintained for much longer duration, for example a period of one to two days. When no visible gas appears to be released from the wine after the second duration, the wine making process can proceed to subsequent steps of additional racking or bottling.

In the second mode of operation, the adapter 34 is similar in form to the previous embodiment in that it similarly fits within the neck of a batch container comprises a carboy. In addition to the vacuum port 40, in the second embodiment of the adapter 34 for use in the second mode of operation there is provided an auxiliary port 44 also communicating through the adapter plug for communication at an inner end with a suitable stem 46 and for connection to a siphon line 48 at an external nipple 49.

The stem 46 is arranged to extend the height of the batch container within which the adapter 34 is received to minimize agitation of wine transferred through the stem. The siphon line 48 also communicates with an auxiliary stem 50 which extends at least a height of the batch container 36 within which the wine is located initially. To transfer the wine from one batch container to a second batch container within which the adapter is received, the vacuum device is operated to produce a vacuum in the target batch container having the adapter 34 therein. The vacuum pressure introduced in the target batch container produces suction on the stem 46 of the adapter which in turn produces suction through the siphon line 48 and to the auxiliary stem 50 in the batch container having the wine initially therein so that the wine in the stem of the siphon line is exposed to the vacuum and drawn through the siphon line to be transferred and deposited into the target batch container within which the adapter 34 is mounted. When transferring wine between two batch containers at an early stage in the wine making process prior to degassing the wine, and it is desirable not to prematurely degas the wine, the control valve 20 operates the vacuum device to limit exposure of the wine to a vacuum pressure having a vacuum which does not exceed a transferring threshold pressure so as to prevent premature degassing of the wine.

According to a further embodiment of the adapter 34 as shown in FIGS. 8 and 9, the vacuum device can be operated in a third mode for bottling wine. Similarly to the pervious embodiment, the adapter 34 in the third mode also includes an auxiliary port 44 communicating through the plug body of the adapter in addition to the vacuum port 40. An inner end of the auxiliary port 44 similarly communicates with a stem 46 which extends down into the target container receiving the adapter 34 therein. In the third mode the target container comprises a wine bottle among plural wine bottles to be filled with wine from the batch container. The body of the adapter 34 in this embodiment is thus arranged to be sealably engaged within the neck opening of the wine bottle with the stem 46 having a suitable length to extend a full height of the wine bottle from the adapter in the neck opening to the bottom of the wine bottle. In each of the second and third modes, the stems have a suitable length to communicate with the respective container within which it is received adjacent a bottom end of the container so as to reduce agitation of the wine being transferred between containers.

The adapter 34 of the third mode of operation also differs in that the vacuum port 40 includes both a main nipple 42 and an auxiliary nipple 54 which communicate in parallel with one another with the vacuum port communicating through the body of the adapter. The main nipple 42 again communicates directly with the vacuum line, however the auxiliary nipple communicates with the vacuum line by branching off the main nipple 42 between the vacuum line and the body of the adapter 34. The auxiliary nipple 54 defines a control port 56 arranged to controllably break vacuum in the vacuum line by selectively introducing air into the vacuum line when the control port 56 is open. Accordingly siphoning action introduced in the siphon line by vacuum pressure in the vacuum line is stopped when the control port is open. Closing the control port however allows the vacuum pressure to be maintained in the vacuum line and in the container within which the adapter 34 is received so that the siphoning action through the siphon line resumes. When bottling, the adapter body 34 in the third mode is received within the neck opening of the bottle and the vacuum device is operated. By closing the control port 56, suction is introduced in the siphon line to draw wine from the batch container receiving the stem 46 therein so that the wine is transferred into the target container comprising the wine bottle being filled. When the bottle is full or near full, the control port 56 is opened to break the vacuum pressure in the vacuum line. By locating the control port 56 adjacent the container at an end of the vacuum line more accurate control of the actuation and release of vacuum pressure in the vacuum line as it operates on the container is permitted. Once a bottle is full, the adapter 34 is removed from the neck of the bottle to allow corking to complete the bottling process and the adapter 34 can be inserted to another bottle for repeating the same operations to fill the next bottle.

As described herein, the device 10 comprises a vacuum pump 14 connected by a vacuum hose, forming a portion of the suction line 16, to an adjustable vacuum valve 20. Another hose forming another portion of the suction line 16 is connected from the valve 20 to the inlet vacuum port 18. The vacuum gauge 21 is attached at the mid point between the control valve and the inlet port 18.

A 110V power cord 24 is attached to device 10 so that electrical power can be supplied to vacuum pump 10 and to the on/off switch. A power step down transformer 28 is attached to the power lines. Low voltage power lines are attached to fan. When the device is turned on, the vacuum pump is supplied power along with the transformer which in turn powers the cooling fan to keep the unit at an optimum operating temperature.

According to a first mode for degassing, the device is attached to a hose which is attached to the degassing bung comprising the first embodiment of the adapter 34. The degassing bung is firmly installed into an industry standard carboy. To degas the wine source, the vacuum valve 20 is initially turned to open. The device is then energized by a switch and an initial low vacuum is then present. By turning the vacuum control valve you will increase the vacuum by about 10 inch lbs. By watching the vacuum gauge, you will see initial degassing of wine at this stage. This setting is typically held for approximately twenty minutes. Slowly closing the vacuum control valve will increase the vacuum pressure. Once the vacuum gauge typically reads approximately 21 inch lbs, active degassing will take place. Leaving the device on and running for approximately 24-48 hours or until you notice all small bubbles gone is typically sufficient for degassing. The vacuum gauge will increase to approximately 28 inch lbs as gas is diminished. When degassing is complete, the device is turned off. Slowly opening the vacuum control valve is then desired until the vacuum gauge is at zero inch lbs. The degassing bung can then be removed and replaced with an industry standard air lock.

According to a second mode for racking wine, a user should initially attach a hose to the device via the inlet port. The hose is then connected to a transfer bung comprising the second embodiment of the adapter 34 which is fitted into clean Industry standard carboy forming the auxiliary batch container. An industry standard hose can then be connected to an industry standard “J” tube stem, which is inserted into the wine source in the initial batch container. Opening the vacuum control valve 20 fully open with the device turned on initiates the transfer of wine between containers. The vacuum gauge should read no more than 4-inch lbs vacuum to prevent premature degassing of the wine. The device will create a low level vacuum in the clean carboy so that wine from the wine source will be sucked through “J” tube to the connected hose and into the transfer bung, thus filling up the carboy. It is important to understand that a low level vacuum needs to be applied to transfer wine. A higher vacuum could prematurely degas your wine before the fermentation process is complete.

According to a third mode for bottling wine, the following steps are performed:

1) Attach a vacuum hose to the device via the vacuum port;

2) attach a hose to the bottling bung comprising the third embodiment of the adapter 34;

3) Insert the bottling bung into a standard 750 ml or 1.5 L wine bottle;

4) Attach an industry standard hose to the bottling bung.

5) Attach an industry standard hose to an industry standard J tube inserted into the wine source.

6) Close the vacuum control valve.

7) Turn the device on via the power switch. With the device on and running, no vacuum will initially be present in the standard wine bottle. The vacuum will be pulled out of the auxiliary port on the bottling bung.

8) Close the vacuum port and the vacuum pressure will be present in the standard wine bottle. Wine will now be pulled from the wine source into the industry standard J tube through the industry standard hose into the bottling bung, filling up the industry standard wine bottle.

9) When Industry standard wine bottle is full to the desired level, open the auxiliary port and the vacuum will be released and the flow will stop.

A wine degasifying system is described above for use with a batch container having a neck opening and being arranged to receive wine corresponding to a plurality of bottles therein. The system comprises a plug 34 arranged to be received in the neck opening of the container in sealing engagement therewith. The plug including a vacuum port 40 communicating therethrough between inner and outer ends of the plug. The vacuum pump 14 is arranged to produce a vacuum pressure at an inlet of the pump in communication with the vacuum line 32 between the vacuum port in the plug and the inlet of the pump. The control valve 20 in communication with the vacuum line is arranged to controllably adjust a magnitude of a vacuum pressure applied by the vacuum pump to the vacuum line.

A wine transferring system is also described above for transferring wine from a batch container arranged to receive wine corresponding to a plurality of bottles therein. The system in this instance comprises an auxiliary batch container having a neck opening and also being arranged to receive the wine therein. The plug 34 is again arranged to be received in the neck opening in sealing engagement therewith. The plug includes a vacuum port 40 and an auxiliary port 44 communicating therethrough between inner and outer ends of the plug. The vacuum pump 14 is again arranged to produce a vacuum pressure at an inlet of the pump. The vacuum line 32 is in communication between the vacuum port in the plug and the inlet of the pump. A siphon line 48 in this instance is arranged for communication between the auxiliary port at the outer end of the plug and the batch container. There is also provided a stem 46 arranged to communicate between the auxiliary port at the inner end of the plug and a bottom end of the auxiliary container. The control valve 20 in this instance is in communication with the vacuum line and is arranged to controllably maintain a magnitude of a vacuum pressure applied by the vacuum pump to the vacuum line below a prescribed vacuum threshold so as to prevent premature degasification of the wine.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. In a method of making wine comprising:
fermenting a mixture in a main batch container to produce wine; and
transferring the wine from the main batch container to a plurality of bottles;
an improvement comprising exposing at least a portion of the wine to a vacuum pressure.

2. The improvement according to claim 1 including applying a vacuum pressure to the main batch container to degas the wine in the main batch container prior to transferring the wine to the plurality of bottles.

3. The improvement according to claim 2 including applying the vacuum pressure to the main batch container at a first prescribed vacuum pressure for an initial prescribed duration followed by a second vacuum pressure greater than the first vacuum pressure for a subsequent duration which is greater than the initial prescribed duration.

4. The improvement according to claim 3 wherein the first prescribed vacuum pressure is approximately 10 psi of vacuum pressure relative to atmosphere.

5. The improvement according to claim 1 including applying the vacuum pressure to an auxiliary container connected to the batch container by a siphon tube.

6. The improvement according to claim 5 including providing an adapter arranged to be sealably engaged within a neck opening of the auxiliary container, the adapter including a first port communicating through the adapter in communication with a source of the vacuum pressure and a second port communicating through the adapter in communication with the siphon tube.

7. The improvement according to claim 6 wherein the siphon tube is arranged to communicate with each of the containers adjacent a bottom end thereof.

8. The improvement according to claim 5 wherein the source of the vacuum pressure is arranged to communicate with the auxiliary container adjacent a top end thereof.

9. The improvement according to any one of claims 1 through 8 including applying the vacuum pressure with a vacuum source comprising a vacuum pump and a controllable valve arranged to controllably set the vacuum pressure applied to the wine to a set point vacuum pressure.

10. The improvement according to claim 9 including providing a pressure gauge in communication with the vacuum source and operating the control valve to introduce air into a vacuum line communicating between the vacuum source and the container until the set point vacuum pressure is indicated on the gauge.

11. The improvement according to claim 5 wherein the auxiliary container comprises an auxiliary batch container arranged to receive the wine therein when racking the wine from the main batch container to the auxiliary batch container.

12. The improvement according to claim 11 including preventing the wine from being prematurely degassed by preventing the vacuum pressure applied to the auxiliary batch container from exceeding a prescribed threshold.

13. The improvement according to claim 5 wherein the auxiliary container comprises one bottle of the plurality of bottles to which the wine from the main batch container is transferred.

14. The improvement according to claim 13 including providing a vacuum line in communication between a source of the vacuum pressure and the auxiliary container and a control port in communication between atmosphere and the vacuum line.

15. The improvement according to claim 14 wherein the control port is adjacent the auxiliary container.

16. A wine degasifying system for use with a batch container having a neck opening and being arranged to receive wine corresponding to a plurality of bottles therein, the system comprising:
a plug arranged to be received in the neck opening in sealing engagement therewith, the plug including a vacuum port communicating therethrough between inner and outer ends of the plug;
a vacuum pump arranged to produce a vacuum pressure at an inlet of the pump;
a vacuum line in communication between the vacuum port in the plug and the inlet of the pump.

17. The system according to claim 16 wherein there is provided a control valve in communication with the vacuum line and arranged to controllably adjust a magnitude of a vacuum pressure applied by the vacuum pump to the vacuum line.

18. A wine transferring system for transferring wine from a batch container arranged to receive wine corresponding to a plurality of bottles therein, the system comprising:
an auxiliary container having a neck opening and being arranged to receive the wine therein;
a plug arranged to be received in the neck opening in sealing engagement therewith, the plug including a vacuum port and an auxiliary port communicating therethrough between inner and outer ends of the plug;
a vacuum pump arranged to produce a vacuum pressure at an inlet of the pump;
a vacuum line in communication between the vacuum port in the plug and the inlet of the pump;
a siphon line arranged for communication between the auxiliary port at the outer end of the plug and the batch container.

19. The system according to claim 18 wherein there is provided a stem arranged to communicate between the auxiliary port at the inner end of the plug and a bottom end of the auxiliary container.

20. The system according to claim 18 wherein there is provided a control valve in communication with the vacuum line and arranged to controllably maintain a magnitude of a vacuum pressure applied by the vacuum pump to the vacuum line below a prescribed vacuum threshold so as to prevent premature degasification of the wine.
